(19) United States
(12) Patent Application Publication
(10) Pub. No.: US 2016/0203482 A1
(43) Pub. Date: Jul. 14, 2016

(54) SYSTEM AND METHOD FOR GENERATING PAYMENT CREDENTIALS

(71) Applicant: VISA INTERNATIONAL SERVICE ASSOCIATION, San Francisco, CA (US)

(72) Inventor: Horatio Nelson Huxham, Cape Town (ZA)

(21) Appl. No.: 14/910,947

(22) PCT Filed: Aug. 13, 2014
(86) PCT No.: PCT/IB2014/063894

§ 371 Date: Feb. 8, 2016

(30) Foreign Application Priority Data
Aug. 15, 2013 (ZA) 201306161

(51) Int. Cl. G06Q 20/40; G06Q 20/38

(52) U.S. Cl. CPC G06Q 20/401; G06Q 20/3821; G06Q 2220/00

(57) ABSTRACT

A method and system for generating payment credentials are provided. A remotely accessible server receives a request for payment credentials for use in conducting a financial transaction, the request originating from a requesting entity and associated with a transaction amount. The remotely accessible server obtains a raw account identifier, pads the raw account identifier with the transaction amount, and performs a predefined calculation on the raw account identifier padded with the transaction amount to yield at least one check digit. The at least one check digit is incorporated into the raw account identifier to yield a processed account identifier for onward transmission to the requesting entity and for use in conducting the financial transaction.

### CROSS-REFERENCES TO RELATED APPLICATIONS

This application claims priority to South African provisional patent application number 2013/06161 entitled “System and Method for Generating and Validating Payment Credentials”, filed on 15 Aug. 2013, which is incorporated by reference herein.

### BACKGROUND

In many existing systems and methods for authorizing financial transactions, some form of payment credentials of a consumer wishing to conduct a transaction are provided to a merchant and/or acquiring entity of the merchant. The validity of these credentials are then determined before the transaction is allowed to proceed.

In card-not-present payment transactions, such as payments made remotely by a consumer to a merchant by means of an e-commerce website or system, a payment may be authorized by determining the validity of two or more credentials associated with a payment card provided by the consumer to the merchant, such as a Primary Account Number (PAN), card expiry date and Card Verification Value (CVV) associated with the payment card.

A notable drawback of this method of payment authorization is that, in many cases, all of the payment credentials required for conducting a card-not-present transaction are physically provided on the payment card of the consumer. These payment credentials can therefore be obtained, for example, if the payment card is lost or stolen, and may then be used for fraudulent purposes by a third party.

Other payment authorization methods enable a consumer to request temporary or dynamic payment credentials using an electronic communications device, typically a mobile phone. If such a request is authorized, payment credentials such as a single-use Primary Account Number (PAN), also referred to as a one-time PAN, and/or a payment reference number, are then issued to the consumer. The consumer may present these payment credentials to a merchant in order to conduct a transaction. These payment credentials typically have a limited lifetime.

While the payment credentials may, in such a case, only be used for a single transaction and/or for a limited period of time, this method still presents the risk of an unscrupulous party obtaining the payment credentials and conducting one or more fraudulent transactions before the credentials expire.

The present invention aims to address these problems, at least to some extent.

### BRIEF SUMMARY

In accordance with the invention there is provided a method of generating payment credentials, the method carried out at a remotely accessible server and comprising the steps of:
receiving a request for payment credentials for use in conducting a financial transaction, the request originating from a requesting entity and associated with a transaction amount;
obtaining a raw account identifier;
padding the raw account identifier with the transaction amount;
performing a predefined calculation on the raw account identifier padded with the transaction amount to yield at least one check digit; and
incorporating the at least one check digit into the raw account identifier to yield a processed account identifier for onward transmission to the requesting entity and for use in conducting the financial transaction.

Further features provide for the request for payment credentials to be a request for single-use payment credentials; for the request for payment credentials to include the transaction amount; for one of the raw account identifier and the processed account identifier to be a bank account number or a number formatted as a bank account number; and for one of the raw account identifier and the processed account identifier to be formatted as a Primary Account Number (PAN).

Yet further features provide for the predefined calculation to be a check digit calculation; for the check digit calculation to be a Luhn modulus 10 check digit calculation; and for a unique seed value to be used to seed the predefined calculation.

The step of obtaining the raw account identifier may include generating the raw account identifier at the remotely accessible server. The step of incorporating the at least one check digit into the raw account identifier to yield a processed account identifier may include appending the at least one check digit to the raw account identifier to yield the processed identifier formatted as a PAN.

A further feature provides for the method to further include the steps of: receiving a processed account identifier and a transaction amount associated with a financial transaction from an acquiring entity or banking switch; disjoining at least one check digit from the received processed account identifier to yield a disjoined raw account identifier and at least one disjoined check digit; padding the disjoined raw account identifier with the received transaction amount; performing the predefined calculation on the disjoined raw account identifier padded with the received transaction amount to yield at least one verification check digit; checking whether the at least one verification check digit matches the at least one disjoined check digit; and if the at least one verification check digit matches the at least one disjoined check digit, allowing the financial transaction to proceed; or if the at least one verification check digit does not match the at least one disjoined check digit, denying the financial transaction.

Further features provide for the step of allowing the financial transaction to proceed to include using the raw account identifier or the processed account identifier to process the financial transaction; alternatively, for the step of allowing the financial transaction to proceed to include replacing the raw account identifier or the processed account identifier with actual payment credentials associated therewith and using the actual payment credentials to process the financial transaction.

Still further features provide for the requesting entity to be a consumer; and for the request for payment credentials to be transmitted from an electronic communications device of the consumer.

The raw account identifier may represent a standard Primary Account Number (PAN) in all respects except that it is devoid of one or more check digit, and the at least one check digit may be incorporated into the raw account identifier such that the processed account identifier represents a standard PAN in all respects.

The invention extends to a method carried out at an electronic communications device of a requesting entity, comprising the steps of: receiving input indicating a selection to request payment credentials; transmitting a request for payment credentials for use in conducting a financial transaction, the request associated with a transaction amount, wherein, at a remotely accessible server, a raw account identifier is padded with the transaction amount for performing a predefined calculation thereon to yield at least one check digit; and receiving a processed account identifier for use in conducting the financial transaction, the processed account identifier having been obtained at the remotely accessible server by incorporating the at least one check digit into the raw account identifier.

The invention further provides a system for generating payment credentials, the system comprising a remotely accessible server including:
a credential request component for receiving a request for payment credentials for use in conducting a financial transaction, the request originating from a requesting entity and associated with a transaction amount;
a raw identifier component for obtaining a raw account identifier;
a padding component for padding the raw account identifier with the transaction amount;
a calculating component for performing a predefined calculation on the raw account identifier padded with the transaction amount to yield at least one check digit; and
a processed identifier component for incorporating the at least one check digit into the raw account identifier to yield a processed account identifier for onward transmission to the requesting entity and for use in conducting the financial transaction.

Further features provide for the remotely accessible server to include: a credential receiving component for receiving a processed account identifier and a transaction amount associated with a financial transaction from an acquiring entity or banking switch; a disjoining component for disjoining at least one check digit from the received processed account identifier to yield a disjoined raw account identifier and at least one disjoined check digit; and a checking component.

The remotely accessible server may be configured to: use the padding component for padding the disjoined raw account identifier with the received transaction amount; use the calculating component for performing the predefined calculation on the disjoined raw account identifier padded with the received transaction amount to yield at least one verification check digit; and use the checking component for checking whether the at least one verification check digit matches the at least one disjoined check digit, such that if the at least one verification check digit matches the at least one disjoined check digit, the financial transaction is allowed to proceed, and if the at least one verification check digit does not match the at least one disjoined check digit, the financial transaction is denied.

Still further features provide for the remotely accessible server to include one or more servers of an issuing entity; for the issuing entity to be an issuing bank; for the issuing entity to be a mobile payment system; for the requesting entity to be a consumer having a financial account held at the issuing entity; and for the financial account to be a mobile money account.

The invention further extends to a system comprising an electronic communications device of a requesting entity, the electronic communications device including: an input receiving component for receiving input indicating a selection to request payment credentials; a transmitting component for transmitting a request for payment credentials for use in conducting a financial transaction, the request associated with a transaction amount, wherein, at a remotely accessible server, a raw account identifier is padded with the transaction amount for performing a predefined calculation thereon to yield at least one check digit; and a processed identifier component for receiving a processed account identifier for use in conducting the financial transaction, the processed account identifier having been obtained at the remotely accessible server by incorporating the at least one check digit into the raw account identifier.

The invention even further extends to a computer program product for generating payment credentials, the computer program product comprising a computer-readable medium having stored computer-readable program code for performing the steps of: receiving a request for payment credentials for use in conducting a financial transaction, the request originating from a requesting entity and associated with a transaction amount; obtaining a raw account identifier; padding the raw account identifier with the transaction amount; performing a predefined calculation on the raw account identifier padded with the transaction amount to yield at least one check digit; and incorporating the at least one check digit into the raw account identifier to yield a processed account identifier for onward transmission to the requesting entity and for use in conducting the financial transaction.

The computer-readable medium may be a non-transitory computer-readable medium, and the computer-readable program code may be executable by a processing circuit.

In order for the invention to be more fully understood, implementations thereof will now be described with reference to the accompanying drawings.

### BRIEF DESCRIPTION OF THE DRAWINGS

FIG. 1A is a schematic illustration of an embodiment of a system for generating payment credentials;

FIG. 1B is a block diagram illustrating components of an embodiment of a remotely accessible server;

FIG. 1C is a block diagram illustrating components of an embodiment of an electronic communications device of a consumer;

FIG. 2 is a swim-lane flow diagram which illustrates a method of generating payment credentials;

FIG. 3A is a first exemplary step-by-step diagram illustrating how payment credentials may be generated and validated;

FIG. 3B is a second exemplary step-by-step diagram illustrating how payment credentials may be generated and validated;

FIG. 4 illustrates a block diagram of a computing device that may be used in various embodiments of the invention; and

FIG. 5 illustrates a block diagram of a communication device in which various aspects of the invention may be implemented.

### DETAILED DESCRIPTION WITH REFERENCE TO THE DRAWINGS

A system and method for generating payment credentials are provided. A remotely accessible server is configured to receive a request for payment credentials originating from a requesting entity and associated with a transaction amount. A raw account identifier is obtained, padded with the transaction amount, and a predefined calculation is performed on the raw account identifier padded with the transaction amount to yield at least one check digit. The at least one check digit is incorporated into the raw account identifier to yield a processed account identifier for onward transmission to the requesting entity and for use in conducting a financial transaction. The processed account identifier may be used as payment credentials by the requesting entity to conduct the financial transaction.

To validate such payment credentials, the remotely accessible server may receive a processed account identifier and a transaction amount associated with a financial transaction from an acquiring entity or banking switch, disjoin at least one check digit from the received processed account identifier to yield a disjoined raw account identifier and at least one disjoined check digit, and pad the disjoined raw account identifier with the received transaction amount. The predefined calculation may then be performed on the disjoined raw account identifier padded with the received transaction amount to yield at least one verification check digit.

The remotely accessible server may check whether the at least one verification check digit matches the disjoined check digit. If the at least one verification check digit matches the at least one disjoined check digit, the financial transaction may be allowed to proceed. If the at least one verification check digit does not match the at least one disjoined check digit, the financial transaction may be denied.

Embodiments described herein provide for information relating to a transaction amount to be essentially embedded into payment credentials without requiring the actual transaction amount to be included therein. One or more check digit calculated at least partially using the transaction amount is incorporated into payment credentials used to conduct a transaction, which may enhance transaction security by associating the payment credentials with a pre-specified transaction amount.

Throughout this specification, the terms “pad”, “padded”, “padding”, or any other derivations thereof, should be interpreted so as to have their widest meaning and should specifically be construed to include juxtaposing at least one number to an identifier such as an account number, appending or joining one or more numbers to an identifier before a first digit of the identifier, after a final digit of the identifier, between digits of the identifier, inserting digits of the number before, after or between various digits of the identifier, or in any other suitable manner.

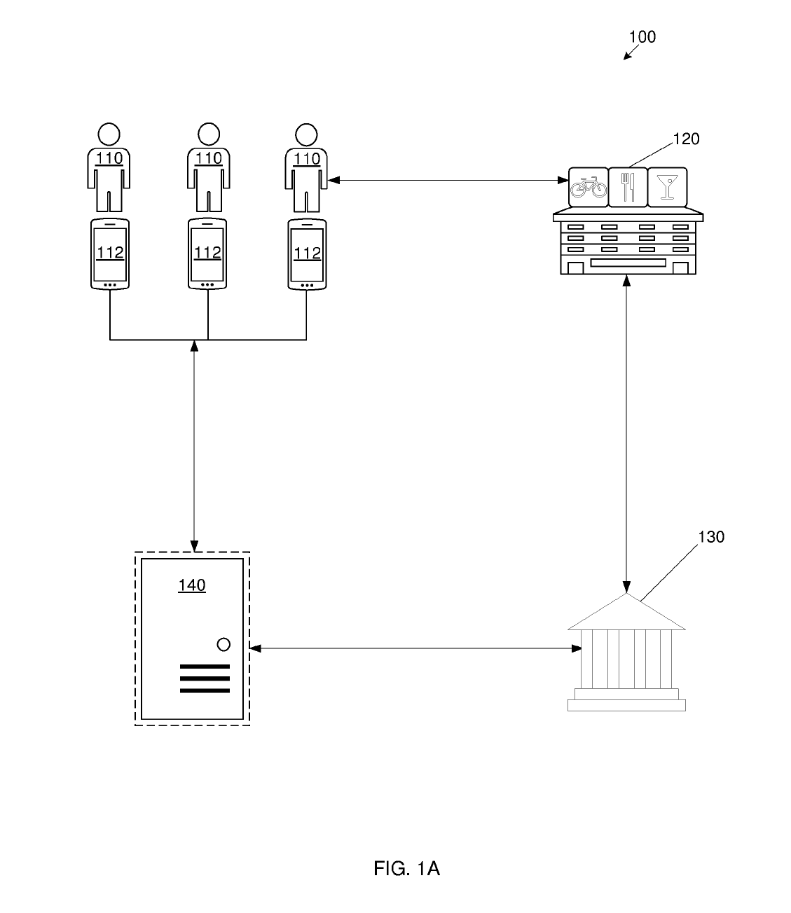

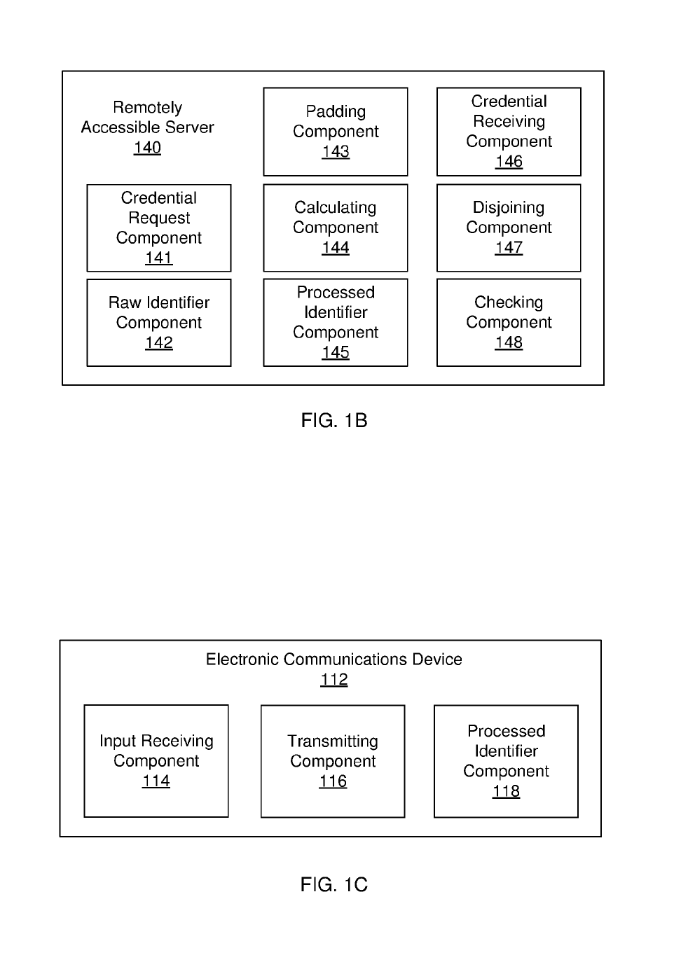

FIG. 1A illustrates an embodiment of a system (100) for generating payment credentials. The system (100) includes a plurality of requesting entities, which are consumers (110) in this embodiment, each consumer (110) having an electronic communications device (112), a merchant (120), an acquiring entity (130) and a remotely accessible server (140).

The remotely accessible server (140) may include one or more servers of or associated with an issuing entity such as an issuing bank of the consumer (110). Each consumer (110) typically holds a financial account at the issuing entity, details of which may be stored at the remotely accessible server (140). In one embodiment, the remotely accessible server (140) is a mobile money server of a mobile payment system. In such a case, each consumer (110) has a registered mobile money account held at the remotely accessible server (140) and the server (140) includes a database with consumer records which contain details of each account, such as a consumer account number, personal information of the consumer, funds available, details of payment instruments, or the like.

The electronic communications device (112) of the consumer (110) may be any electronic communications device capable of communicating over a communications network, such as a cellular communications network or the Internet. The term should be interpreted to specifically include all mobile or cellular phones, including so-called “feature phones” and smartphones, and may also include other electronic communications devices such as computers, laptops, handheld personal computers, personal digital assistants, tablet computers, and the like. In the embodiment of FIG. 1A, the electronic communications device (112) is a mobile phone of the consumer (110).

The remotely accessible server (140) may be configured to transmit communications to and receive communications from the acquiring entity (130) and the electronic communications devices (112) of the consumers (110) over any suitable communications network or networks, which may be, among many others, a mobile communications network and/or the Internet.

Embodiments provide for communications transmitted to and from the remotely accessible server (140), the acquiring entity (130), the merchant (120) and/or the electronic communications device (112) of the consumer (110) to be secure communications across an encrypted communication channel such as Hypertext Transfer Protocol Secure (HTTPS), Transport Layer Security/Secure Sockets Layer (TLS/SSL) or other secure channel.

The remotely accessible server (140) may be any issuing entity, part thereof or entity authorized by an issuing entity to generate and issue an account identifier, preferably in the form of payment credentials, to the consumer (110) for conducting one or more financial transactions. The issuing entity may be an issuing bank. Alternatively, the issuing entity may be a secure financial gateway, a mobile money platform, or a payment processing network or system. The acquiring entity (130) may be a banking switch or an acquiring bank of the merchant (120).

Logical components of an embodiment of the remotely accessible server (140) are shown in FIG. 1B. The remotely accessible server (140) may include a credential request component (141) for receiving a request for payment credentials for use in conducting a financial transaction, a raw identifier component (142) for obtaining a raw account identifier, a padding component (143) for padding the raw account identifier with a transaction amount associated with the financial transaction, and a calculating component (144) for performing a predefined calculation on the raw account identifier padded with the transaction amount to yield at least one check digit.

The remotely accessible server (140) may also include a processed identifier component (145) for incorporating the at least one check digit into the raw account identifier to yield a processed account identifier for onward transmission to the requesting entity and for use in conducting the financial transaction.

In some embodiments, the remotely accessible server (140) may include a credential receiving component (146) for receiving a processed account identifier and a transaction amount associated with a financial transaction from an acquiring entity or banking switch, a disjoining component (147) for disjoining at least one check digit from the received processed account identifier to yield a disjoined raw account identifier and at least one disjoined check digit, and a checking component (148).

Logical components of an embodiment of the electronic communications device (112) are shown in FIG. 1C. The electronic communications device (112) may include an input receiving component (114) for receiving input indicating a selection to request payment credentials, a transmitting component (116) for transmitting a request for payment credentials, and a processed identifier component (118) for receiving a processed account identifier for use in conducting a financial transaction, as will be described in greater detail in what follows.

The system (100) may enable the consumer (110) to request and receive payment credentials, which may be single-use payment credentials, and which can be provided to a merchant to initiate and/or authorize a transaction.

In some embodiments, the payment credentials represent actual payment credentials such as a bank account number or payment account number of the consumer (110) associated with a financial account held at the issuing entity, which is then used to process the payment if the transaction is ultimately allowed to proceed. In alternative embodiments, the payment credentials simply include a financial account identifier or pseudo-card details which is associated and replaced with actual payment credentials if the transaction is allowed to proceed.

The payment credentials may include any one, a combination of, or more of: a bank account number, a PAN, a pseudo-PAN, an obfuscated PAN, a consumer alias, a card expiry date, a Card Verification Value (CVV), a passcode, a Personal Identification Number (PIN), a payment reference number, and the like. In what follows, the term “account identifier” should be interpreted so as to have its broadest meaning and is used to refer to any suitable payment credentials requested by the consumer. The account identifier may also be used in conjunction with other static or dynamic payment credentials which are to be provided to a merchant.

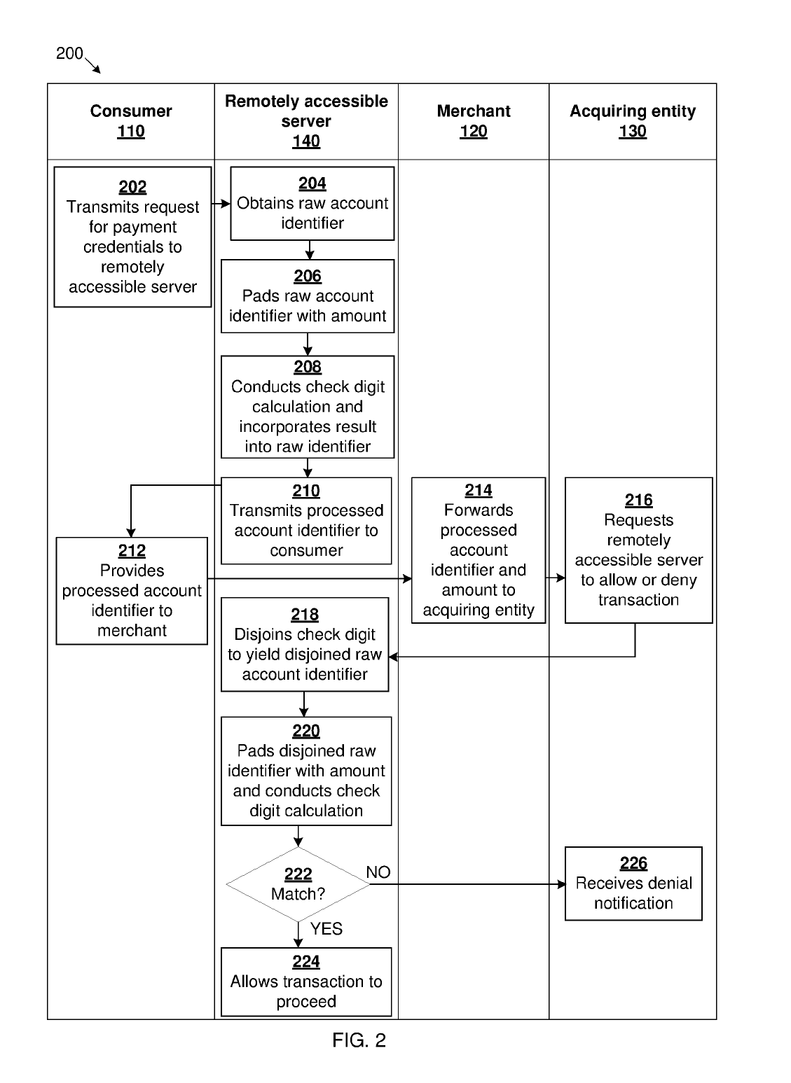

The swim-lane flow diagram (200) of FIG. 2 illustrates a method of generating payment credentials using the system (100) described with reference to FIGS. 1A to 1C. The diagram (200) indicates the roles and/or responsibilities that the consumer (110), the merchant (120), the acquiring entity (130) and the remotely accessible server (140) may have in some embodiments.

At a first stage (202), the consumer (110) transmits a request for payment credentials to the remotely accessible server (140) using the electronic communications device (112). The consumer (110) thus acts as the requesting entity from which the request for payment credentials originates. The request may include a transaction amount which is to be associated with a transaction which the consumer (110) desires to conduct or have conducted on his or her behalf by making use of payment credentials, which are single-use payment credentials in this embodiment. In other embodiments, the request may originate from a different entity such as a payment service provider or other financial institution at which the consumer holds an account.

The electronic communications device (112) may receive input indicating a selection to request payment credentials at its input receiving component (114), and transmit the request described above using its transmitting component (116).

Communications between the remotely accessible server (140) and the electronic communications device (112) of the consumer (110) may typically be effected by way of Short Message Service (SMS) protocol, Unstructured Supplementary Service Data (USSD) protocol, over a secure Internet connection, or by way of data communication enabled by a mobile software application installed on the electronic communications device (112) of the consumer (110). For example, the consumer (110) may access an application menu on a software application resident on and executable by the electronic communications device (112), enter the applicable transaction amount, and select a “request one-time payment credentials” option.

The remotely accessible server (140) may receive the request at its credential request component (141), the request sent from the electronic communications device (112) and in this case including the transaction amount. It should be appreciated that the request need not include the transaction amount, and that the amount may in such a case be obtained as a separate notification, via a different channel, and/or from some other authorized entity.

At a next stage (204), the remotely accessible server (140) obtains a raw account identifier using its raw identifier component (142). The raw account identifier represents a partial account identifier which is, at a later stage, combined with at least one check digit to form a processed, or complete, account identifier, which is then transmitted to the consumer (110) for use in conducting the transaction.

To obtain the raw account identifier, the remotely accessible server (140) may generate the raw account identifier or obtain it from another entity. The remotely accessible server (140) may, for example, be operated by an issuing bank which requests the raw account identifier from a payment processing network.

In one embodiment, the raw account identifier is formatted as a bank account number, more preferably a Primary Account Number (PAN), but without the check digit which is conventionally the final digit of a PAN. A standard PAN may typically be 16 digits in length and consists of a six-digit Issuer Identification Number (IIN) (also known as a “Bank Identification Number” (BIN)), the first digit of which is the Major Industry Identifier (MII), a variable length (commonly up to 12 digits) individual account identifier, and a single check digit calculated using the Luhn modulus 10 check digit algorithm.

In some embodiments, the raw account identifier is thus generated so as to represent a standard PAN in all respects but for one or more check digits such that at least one check digit can be incorporated therein to form a processed account identifier which represents a standard PAN in all respects. In other words, the raw account identifier may comprise an IIN or BIN and an individual account identifier uniquely identifying the financial account of the consumer held at the issuing entity, but may be devoid of a check digit.

The raw account identifier or the processed account identifier may be a bank account number or a number formatted as a bank account number, and the raw account identifier or the processed account identifier may be formatted as a Primary Account Number (PAN).

The individual account identifier uniquely identifies the financial account of the consumer (110) held at the issuing entity such that payments made by the consumer using such payment credentials can be routed to and processed against the appropriate financial account.

It should be appreciated that the raw account identifier may be generated in any other suitable format, including but not limited to the payment credential formats listed above. Furthermore, it should be noted that the remotely accessible server or issuing entity may generate the raw account identifier or, upon receipt of a request for payment credentials, proceed to route this request to a separate “credential generator” such as a one-time PAN generator of a mobile payment system, and subsequently receive the generated payment credentials from the credential generator.

At a next stage (206), the remotely accessible server (140) uses its padding component (143) to pad the raw account identifier with the transaction amount. For example, the transaction amount may be included at the beginning or the end of the raw account identifier, or between digits of the account identifier. In one embodiment, the digits of the transaction amount are sequentially appended to the raw account identifier.

In cases where the transaction amount is not an integer amount, it may be rounded off to an integer amount using any suitable rule. Alternatively, fractions such as “cents” may be included in the transaction amount padded to the raw account identifier in any suitable manner. Alternatively, the consumer may only be capable of requesting a transaction involving an integer amount, in which case a merchant may provide change or credit to the consumer if the amount exceeds a payment price.

The remotely accessible server (140), at a next stage (208), conducts a predefined calculation on the raw account identifier which has been padded with the transaction amount to yield a check digit. The remotely accessible server (140) may use its calculating component (144) to perform any suitable calculation. The predefined calculation may be a check digit algorithm such as the Luhn modulus 10 algorithm. Alternatively, check algorithms such as the Verhoeff algorithm, the Damm algorithm, or the like may be employed.

Once the check digit has been calculated, it is incorporated into the raw account identifier. This may be accomplished by using the processed identifier component (145) to pad the raw account identifier with the check digit using any of the methods described above. In one embodiment, the check digit is appended to the raw account identifier. The incorporation of the check digit into the raw account identifier yields a processed account identifier, which is formatted as a complete PAN in some embodiments.

It should be appreciated that the check digit calculation may yield more than one check digit and/or that the raw account identifier may be padded with more than one check digit, depending on the implementation. Furthermore, the one or more check digit may be padded to the raw account identifier more than once, for example, to the beginning and end of the raw account identifier.

The processed account identifier is typically stored in a database or other central storage in association with the financial account of the consumer (110) to enable the financial account of the consumer to be identified during a transaction using the processed account identifier. As stated above, the processed account identifier may either represent actual payment credentials of the consumer (110), or may simply consist of an alias, a financial account identifier or pseudo-card details which is associated and replaced with actual payment credentials if the transaction is allowed to proceed.

The processed account identifier is then, at a next stage (210), transmitted to the electronic communications device (112) of the consumer (110) and may be received using its processed identifier component (118). The consumer (110) may then use the processed account identifier to conduct a transaction for the specific transaction amount stipulated in the initial request for payment credentials.

The consumer (110) may initiate the transaction by providing, at a next stage (212), the processed account identifier to the merchant (120) for a transaction having the appropriate transaction amount. For example, if the consumer (110) requests payment credentials for a transaction having a transaction amount of $10, the consumer (110) should only present the processed account identifier received in response to such a request to conduct a transaction having that specific transaction amount, or an amount rounded from that amount as described above.

At a next stage (214), the merchant (120) forwards the processed account identifier and the transaction amount associated with the financial transaction to the acquiring entity (130). The acquiring entity (130), at a next stage (216), routes these details to the remotely accessible server (140) and requests the remotely accessible server (140) to allow or deny the transaction.

The remotely accessible server (140) may receive the processed account identifier and the transaction amount at its credential receiving component (146). The position of the check digit in the processed account identifier may be ascertained and, at a next stage (218), the disjoining component (147) may be used to disjoin the check digit from the processed account identifier to yield the original, raw account identifier and a disjoined check digit. In some embodiments, more than one check digit may be disjoined from the processed account identifier.

At a next stage (220), the padding component (143) may be used to pad the disjoined raw account identifier with the received transaction amount in the same manner as the manner in which the raw account identifier, at the prior stage (206), is padded with the transaction amount for which payment credentials are requested by the consumer (110). The calculating component (114) may be used to conduct the same predefined calculation as is conducted at the prior stage (208) on the disjoined raw account identifier padded with the received transaction amount to yield a verification check digit or more than one verification check digit.

The remotely accessible server (140), at a next stage (222), uses the checking component (148) and checks whether the verification check digit obtained by conducting the predefined calculation on the disjoined raw account identifier padded with the received transaction amount associated with the financial transaction matches the disjoined check digit which was obtained from the processed account identifier received from the acquiring entity (130).

If the verification check digit matches the disjoined check digit, at a next stage (224), the remotely accessible server (224) allows the transaction to proceed, typically in accordance with conventional banking and transaction processing protocol. Alternatively, if the verification check digit does not match the check digit disjoined from the processed account identifier, the transaction is denied at a final stage (226), and the acquiring entity (130) receives a notification that the transaction has been denied, the notification optionally including details of the reasons for the denial.

It is foreseen that similar notifications may also be transmitted to the consumer (110) and/or to the merchant (120) to indicate that the transaction has been denied, or, in other cases, to indicate that the transaction has been allowed to proceed.

The method described with reference to FIG. 2 may therefore provide an additional level of security during authorization or processing of a transaction. A consumer requests payment credentials, typically single-use payment credentials such as a one-time PAN, and also selects a transaction amount. The payment credentials provided to the consumer then includes a check digit which is derived from an account identifier and the transaction amount in combination, such that the payment credentials may only be presented to successfully conduct a transaction of the specific, corresponding transaction amount (unless a provided amount coincidentally leads to a correct check digit).

When the consumer subsequently initializes the transaction, the same check digit calculation may be performed on the processed account identifier (without its check digit) presented by the consumer to the merchant along with the transaction amount associated with the initialized transaction. The transaction will only be allowed to proceed if the resulting check digit matches the original check digit incorporated into the processed account identifier.

For example, if a consumer requests payment credentials for conducting a transaction having a transaction amount of $10, but subsequently presents the payment credentials to initialize a transaction having a different transaction amount, depending on the transaction amount of the actual transaction, the verification check digit may, at least in the majority of cases, not match the check digit of the processed account identifier, causing the transaction to be declined. Therefore, if the payment credentials are intercepted by a fraudulent party, the fraudulent party may have to have knowledge of the exact amount for which the credentials were requested in order to, in the majority of cases, successfully conduct one or more fraudulent transactions using the intercepted payment credentials. It should be appreciated that, being temporary payment credentials, the credentials may be cancelled or invalidated at the first attempt to use them with an incorrect transaction amount.

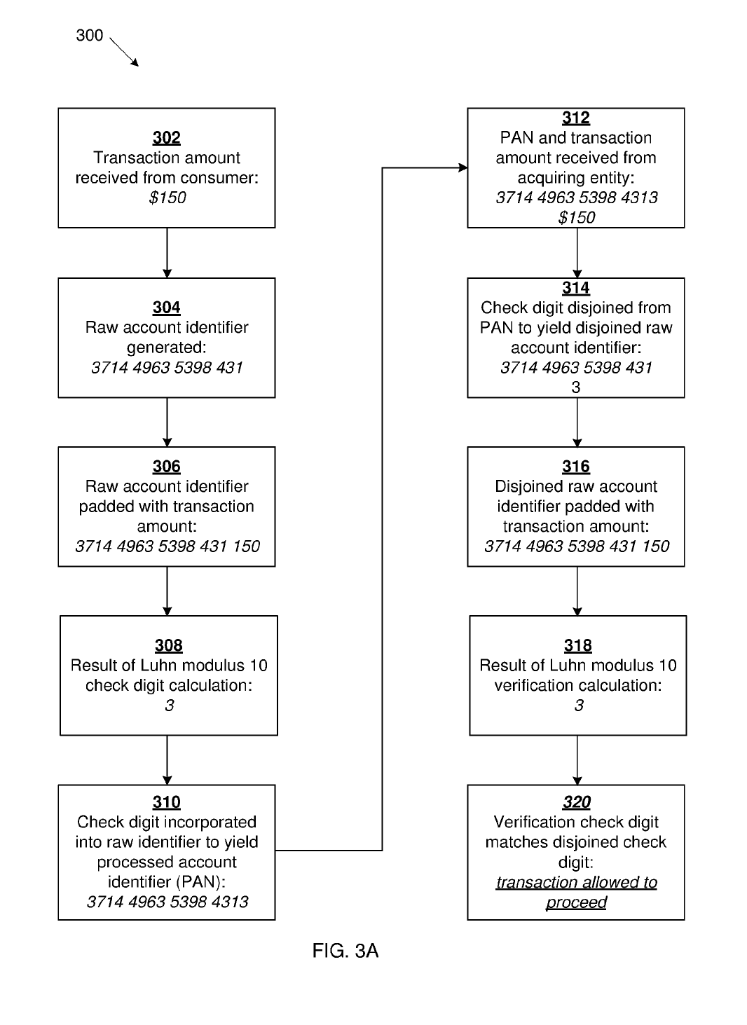

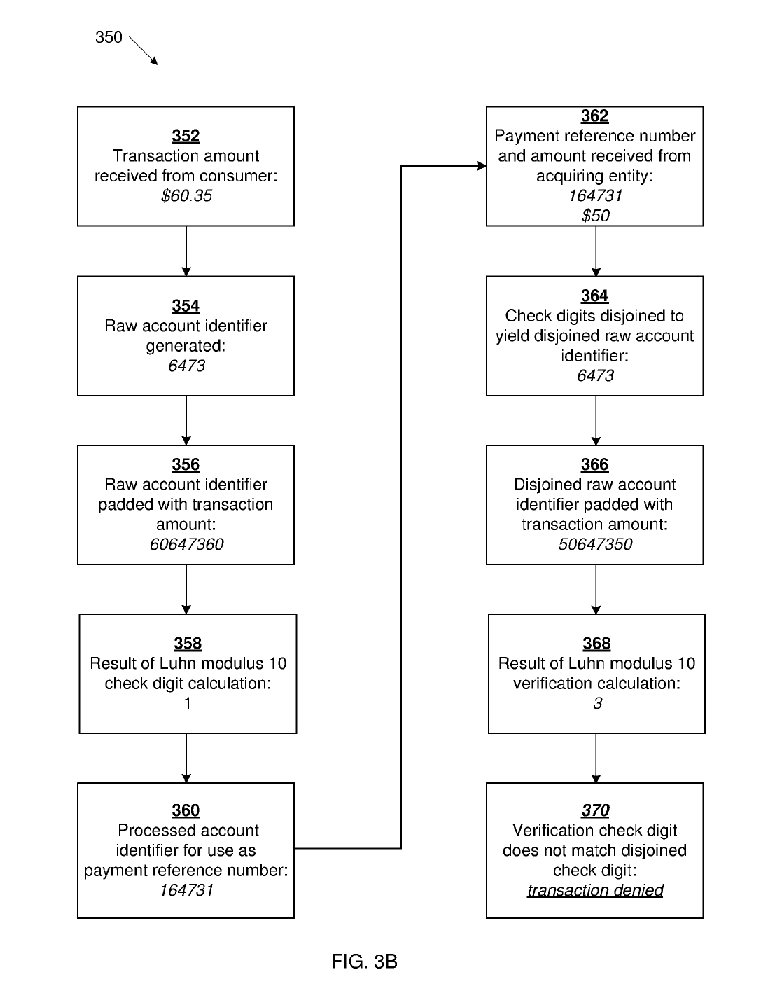

The block diagram (300) of FIG. 3A is a first exemplary step-by-step illustration of a scenario in which payment credentials are generated and validated according to an embodiment. This example is provided for illustrative purposes and is should be appreciated that numerous modifications and alternative configurations may be implemented without departing significantly from the scope of the invention.

At first stage (302), the consumer requests payment credentials to be generated for conducting a transaction having a transaction amount of $150. The following raw account identifier is generated at a next stage (304): 3714 4963 5398 431. The raw account identifier may represent a standard Primary Account Number (PAN) in all respects except that it is devoid of one or more check digit.

At a next stage (306), the raw account identifier is padded with the transaction amount to yield to following sequence of digits: 3714 4963 5398 431 150. A predefined calculation, in this example a Luhn modulus 10 check digit calculation, is then performed on the sequence of digits stipulated with reference to the previous stage (306) to yield, at a next stage (308), the following check digit: 3.

At a next stage (310), the check digit is incorporated into the raw account identifier without the transaction amount to yield a processed account identifier in the form of a 16-digit PAN: 3714 4963 5398 4313. This PAN is then transmitted to the consumer. It is foreseen that the PAN, or other payment credentials, as the case may be, may be submitted to the consumer in one electronic message, while a separate electronic message may be transmitted to the consumer which confirms the transaction amount for which the PAN is valid. In one embodiment, the PAN and the transaction amount are transmitted to the consumer “out-of-band”, through separate channels, and/or by way of separate messages for improved security. For example, the PAN may be transmitted in a SMS message while the transaction amount is confirmed via e-mail.

After the consumer initializes the transaction and presents the processed account identifier to the merchant, these details are routed, at a next stage (312), to the remotely accessible server for validation. In this case, the consumer correctly initializes a transaction for an amount of $150, which corresponds to the transaction amount specified in the initial request for payment credentials.

The remotely accessible server, at a next stage (314), disjoins the check digit from the processed account identifier so that, at a next stage (316), the raw account identifier received from the merchant via the acquiring entity can be padded with the received transaction amount associated with the transaction initialized by the consumer. The following sequence of digits is formed: 3714 4963 5398 431 150.

In this case, because of the fact that the correct transaction amount is presented, the sequence of digits formed by the disjoined raw account identifier and received transaction amount match the original sequence used to generate the check digit for the processed account identifier.

As a result, the same check digit (3) is obtained at a next stage (318) after conducting the same check digit calculation on the sequence of digits stipulated with reference to the previous stage (316). At a final stage (320), it is determined that the verification check digit matches the disjoined check digit, and the transaction is allowed to proceed.

It should be appreciated that the remotely accessible server may use a unique, undisclosed seed value to seed the check digit calculation. Because the seed value is not known to a potential interceptor of the information, the same check digit will not likely be obtained by conducting the check digit calculation.

The block diagram (350) of FIG. 3B is a second exemplary step-by-step illustration of a scenario in which payment credentials are generated and validated.

At first stage (352), the consumer requests payment credentials to be generated for conducting a transaction having a transaction amount of $60.35. In this embodiment, the remotely accessible server uses a predefined rounding rule and rounds the transaction amount to $60. The following raw account identifier is generated at a next stage (354): 6473. In this example, neither the raw account identifier nor the processed account identifier is a PAN. The processed account identifier is simply a payment reference number which must be presented along with static payment credentials for transaction authorization.

At a next stage (356), the raw account identifier is padded with the transaction amount to yield to following sequence of digits: 60647360. In this case, the transaction amount is padded to the beginning and the end of the raw account identifier. A check digit calculation, in this example a Luhn modulus 10 calculation, is then performed on the sequence of digits to yield, at a next stage (358), the following check digit: 1.

At a next stage (360), the check digit is incorporated into the raw account identifier identified with reference to the prior stage (354) to yield a processed account identifier in the form of a payment reference number: 164731. In this example, the check digit is incorporated to the raw account identifier by inserting it both at the beginning and the end of the raw account identifier. The processed account identifier is then transmitted to the consumer.

In this example, an unscrupulous party then obtains the processed account identifier, initializes a transaction and presents the processed account identifier to a merchant. The unscrupulous party attempts to conduct a transaction having a transaction amount of $50 instead of $60 (as requested by the requesting entity). These details are routed, at a next stage (362), to the remotely accessible server for validation.

The remotely accessible server, at a next stage (364), disjoins the check digits from the processed account identifier so that, at a next stage (366), the disjoined raw account identifier can be padded with the received transaction amount in the same way it was padded to initially obtain the check digit. The following sequence of digits is formed: 50647350.

In this case, because of the fact that the incorrect transaction amount was provided, the sequence of digits formed by the raw account identifier and transaction amount received from the acquiring entity does not match the original sequence used to generate the check digit for the processed account identifier.

As a result, a different verification check digit (3) is obtained at a next stage (368) after conducting the same check digit calculation on the sequence of digits stipulated with reference to the previous stage (366). At a final stage (370), it is determined that the verification check digit, in this case “3”, does not match the disjoined check digit, in this case “1”, and the transaction is denied.

A system and method for generating and/or validating payment credentials is therefore provided. The system and method described herein may reduce the risk of payment credentials which are intercepted, or otherwise obtained by unscrupulous parties, being used to conduct one or more fraudulent transactions. At least two separate items of payment data may be required to successfully complete a transaction: the correct transaction amount and the corresponding payment credentials. Therefore, such a person may need to intercept or otherwise obtain both of these items of payment data to be sure that a transaction can be successfully conducted.

A method is thus provided for essentially encoding a transaction amount for which payment credentials are valid into the payment credentials itself. Therefore, it may not be necessary for the issuing entity, or any other entity involved in authorizing the transaction, to store the transaction amount initially specified by the consumer for subsequent checking.

It should be appreciated that separate entities or components may be employed for generating payment credentials and subsequently validating payment credentials. For example, a first entity may include a credential request component, raw identifier component, padding component and calculating component and be responsible for generating the processed account identifier as described for transmission to the requesting entity, while a second entity may include a credential receiving component, disjoining component, calculating component and a checking component and be responsible for checking whether a processed account identifier received from an acquiring entity or banking switch is valid for a transaction of a certain amount, also as described herein. In some embodiments, a merchant may be capable of checking whether a processed account identifier is valid for a transaction of a certain amount without needing to route a transaction request for that amount to a remote server via its acquiring entity or banking switch. The merchant may, for example, be provided with a mobile software application for performing such checks.

Embodiments described herein may be implemented using a computer program product for generating payment credentials. The computer program product may comprise a computer-readable medium having stored computer-readable program code for performing one or more of the steps of: receiving a request for payment credentials for use in conducting a financial transaction, the request originating from a requesting entity and associated with a transaction amount, obtaining a raw account identifier, padding the raw account identifier with the transaction amount; performing a predefined calculation on the raw account identifier padded with the transaction amount to yield at least one check digit, and incorporating the at least one check digit into the raw account identifier to yield a processed account identifier for onward transmission to the requesting entity and for use in conducting the financial transaction.

The computer-readable medium may be a non-transitory computer-readable medium, and the computer-readable program code may be executable by a processing circuit.

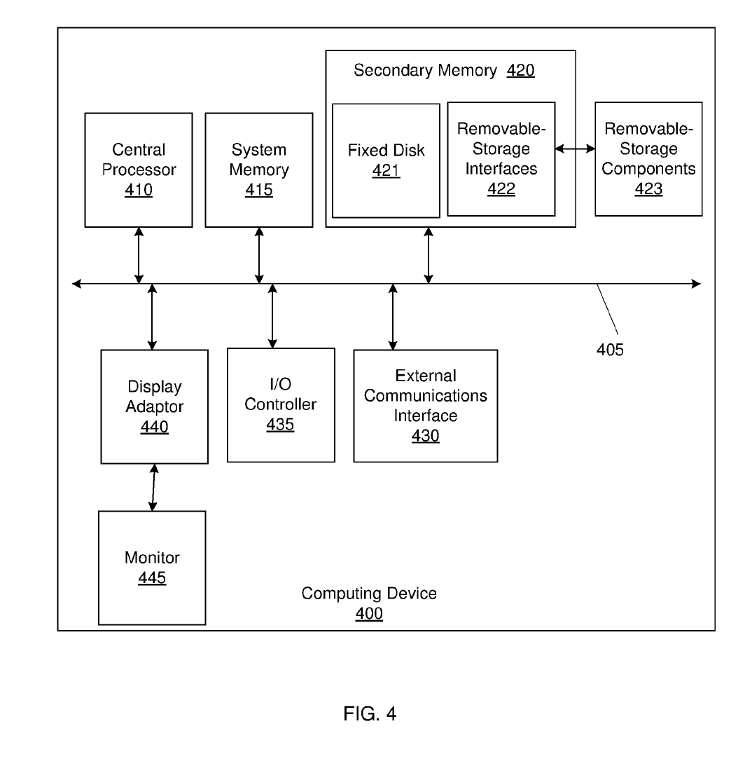

FIG. 4 illustrates an example of a computing device (400) in which various aspects of the disclosure may be implemented. The computing device (400) may be suitable for storing and executing computer program code. The various participants and elements in the previously described system diagrams may use any suitable number of subsystems or components of the computing device (400) to facilitate the functions described herein.

The computing device (400) may include subsystems or components interconnected via a communication infrastructure (405) (for example, a communications bus, a cross-over bar device, or a network). The computing device (400) may include at least one central processor (410) and at least one memory component in the form of computer-readable media.

The memory components may include system memory (415), which may include read only memory (ROM) and random access memory (RAM). A basic input/output system (BIOS) may be stored in ROM. System software may be stored in the system memory (415) including operating system software.

The memory components may also include secondary memory (420). The secondary memory (420) may include a fixed disk (421), such as a hard disk drive, and, optionally, one or more removable-storage interfaces (422) for removable-storage components (423).

The removable-storage interfaces (422) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (422) may also be in the form of ports or sockets for interfacing with other forms of removable-storage components (423) such as a flash memory drive, external hard drive, or removable memory chip, etc.

The computing device (400) may include an external communications interface (430) for operation of the computing device (400) in a networked environment enabling transfer of data between multiple computing devices (400). Data transferred via the external communications interface (430) may be in the form of signals, which may be electronic, electromagnetic, optical, radio, or other types of signal.

The external communications interface (430) may enable communication of data between the computing device (400) and other computing devices including servers and external storage facilities. Web services may be accessible by the computing device (400) via the communications interface (430).

The external communications interface (430) may also enable other forms of communication to and from the computing device (400) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (410).

A computer program product may be provided by a non-transient computer-readable medium, or may be provided via a signal or other transient means via the communications interface (430).

Interconnection via the communication infrastructure (405) allows a central processor (410) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (400) either directly or via an I/O controller (435). These components may be connected to the computing device (400) by any number of means known in the art, such as a serial port.

One or more monitors (445) may be coupled via a display or video adapter (440) to the computing device (400).

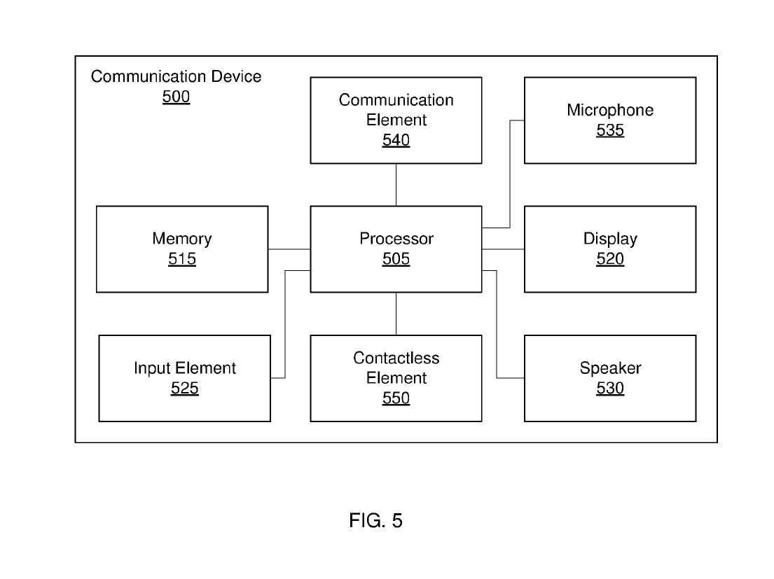

FIG. 5 shows a block diagram of a communication device (500) that may be used in embodiments of the disclosure. The communication device (500) may be a cell phone, a feature phone, a smart phone, a satellite phone, or a computing device having a phone capability.

The communication device (500) may include a processor (505) (e.g., a microprocessor) for processing the functions of the communication device (500) and a display (520) to allow a user to see the phone numbers and other information and messages. The communication device (500) may further include an input element (525) to allow a user to input information into the device (e.g., input buttons, touch screen, etc.), a speaker (530) to allow the user to hear voice communication, music, etc., and a microphone (535) to allow the user to transmit his or her voice through the communication device (500).

The processor (510) of the communication device (500) may connect to a memory (515). The memory (515) may be in the form of a computer-readable medium that stores data and, optionally, computer-executable instructions.

The communication device (500) may also include a communication element (540) for connection to communication channels (e.g., a cellular telephone network, data transmission network, Wi-Fi network, satellite-phone network, Internet network, Satellite Internet Network, etc.). The communication element (540) may include an associated wireless transfer element, such as an antenna.

The communication element (540) may include a subscriber identity module (SIM) in the form of an integrated circuit that stores an international mobile subscriber identity and the related key used to identify and authenticate a subscriber using the communication device (500). One or more subscriber identity modules may be removable from the communication device (500) or embedded in the communication device (500).

The communication device (500) may further include a contactless element (550), which is typically implemented in the form of a semiconductor chip (or other data storage element) with an associated wireless transfer element, such as an antenna. The contactless element (550) may be associated with (e.g., embedded within) the communication device (500) and data or control instructions transmitted via a cellular network may be applied to the contactless element (550) by means of a contactless element interface (not shown). The contactless element interface may function to permit the exchange of data and/or control instructions between mobile device circuitry (and hence the cellular network) and the contactless element (550).

The contactless element (550) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (500) and an interrogation device. Thus, the communication device (500) may be capable of communicating and transferring data and/or control instructions via both a cellular network and near field communications capability.

The data stored in the memory (515) may include: operation data relating to the operation of the communication device (500), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the communication device (500) to selected receivers.

The communication device (500) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method of generating payment credentials, the method carried out at a remotely accessible server and comprising the steps of:
receiving a request for payment credentials for use in conducting a financial transaction, the request originating from a requesting entity and associated with a transaction amount;
obtaining a raw account identifier;
padding the raw account identifier with the transaction amount;
performing a predefined calculation on the raw account identifier padded with the transaction amount to yield at least one check digit; and
incorporating the at least one check digit into the raw account identifier to yield a processed account identifier for onward transmission to the requesting entity and for use in conducting the financial transaction.

2. The method as claimed in claim 1, wherein the request for payment credentials is a request for single-use payment credentials.

3. The method as claimed in claim 1, wherein one of the raw account identifier and the processed account identifier is formatted as a Primary Account Number (PAN).

4. The method as claimed in claim 1, wherein the predefined calculation is a check digit calculation.

5. The method as claimed in claim 4, wherein the check digit calculation is a Luhn modulus 10 check digit calculation.

6. The method as claimed in claim 1, wherein a unique seed value is used to seed the predefined calculation.

7. The method as claimed in claim 1, wherein the step of obtaining the raw account identifier includes generating the raw account identifier at the remotely accessible server.

8. The method as claimed in claim 1, wherein the raw account identifier represents a standard Primary Account Number (PAN) in all respects except that it is devoid of one or more check digit, and wherein the at least one check digit is incorporated into the raw account identifier such that the processed account identifier represents a standard PAN in all respects.

9. The method as claimed in claim 1, wherein the step of incorporating the at least one check digit into the raw account identifier to yield a processed account identifier includes appending the at least one check digit to the raw account identifier to yield the processed account identifier formatted as a Primary Account Number (PAN).

10. The method as claimed in claim 1, wherein the requesting entity is a consumer and wherein the request for payment credentials is transmitted from an electronic communications device of the consumer.

11. The method as claimed in claim 1, further comprising the steps of:
receiving a processed account identifier and a transaction amount associated with a financial transaction from an acquiring entity or banking switch;
disjoining at least one check digit from the received processed account identifier to yield a disjoined raw account identifier and at least one disjoined check digit;
padding the disjoined raw account identifier with the received transaction amount;
performing the predefined calculation on the disjoined raw account identifier padded with the received transaction amount to yield at least one verification check digit;
checking whether the at least one verification check digit matches the at least one disjoined check digit; and
if the at least one verification check digit matches the at least one disjoined check digit, allowing the financial transaction to proceed; or
if the at least one verification check digit does not match the at least one disjoined check digit, denying the financial transaction.

12. The method as claimed in claim 11, wherein the step of allowing the financial transaction to proceed includes using the raw account identifier or the processed account identifier to process the financial transaction.

13. The method as claimed in claim 11, wherein the step of allowing the financial transaction to proceed includes replacing the raw account identifier or the processed account identifier with actual payment credentials associated therewith and using the actual payment credentials to process the financial transaction.

14. A computer-implemented method carried out at an electronic communications device of a requesting entity, comprising the steps of:
receiving input indicating a selection to request payment credentials;
transmitting a request for payment credentials for use in conducting a financial transaction, the request associated with a transaction amount, wherein, at a remotely accessible server, a raw account identifier is padded with the transaction amount for performing a predefined calculation thereon to yield at least one check digit; and
receiving a processed account identifier for use in conducting the financial transaction, the processed account identifier having been obtained at the remotely accessible server by incorporating the at least one check digit into the raw account identifier.

15. A system for generating payment credentials, the system comprising a remotely accessible server having a processor and a memory component providing computer-executable instructions, the server including:
a credential request component for receiving a request for payment credentials for use in conducting a financial transaction, the request originating from a requesting entity and associated with a transaction amount;
a raw identifier component for obtaining a raw account identifier;
a padding component for padding the raw account identifier with the transaction amount;
a calculating component for performing a predefined calculation on the raw account identifier padded with the transaction amount to yield at least one check digit; and
a processed identifier component for incorporating the at least one check digit into the raw account identifier to yield a processed account identifier for onward transmission to the requesting entity and for use in conducting the financial transaction.

16. The system as claimed in claim 15, wherein the remotely accessible server further includes:
a credential receiving component for receiving a processed account identifier and a transaction amount associated with a financial transaction from an acquiring entity or banking switch;
a disjoining component for disjoining at least one check digit from the received processed account identifier to yield a disjoined raw account identifier and at least one disjoined check digit; and
a checking component, wherein the remotely accessible server is further configured to:
use the padding component for padding the disjoined raw account identifier with the received transaction amount;
use the calculating component for performing the predefined calculation on the disjoined raw account identifier padded with the received transaction amount to yield at least one verification check digit; and
use the checking component for checking whether the at least one verification check digit matches the at least one disjoined check digit, such that if the at least one verification check digit matches the at least one disjoined check digit, the financial transaction is allowed to proceed, and if the at least one verification check digit does not match the at least one disjoined check digit, the financial transaction is denied.

17. A system comprising an electronic communications device of a requesting entity, the electronic communications device having a processor for processing the functions of the device and a memory including computer-readable instructions, and including:
an input receiving component for receiving input indicating a selection to request payment credentials;
a transmitting component for transmitting a request for payment credentials for use in conducting a financial transaction, the request associated with a transaction amount, wherein, at a remotely accessible server, a raw account identifier is padded with the transaction amount for performing a predefined calculation thereon to yield at least one check digit; and
a processed identifier component for receiving a processed account identifier for use in conducting the financial transaction, the processed account identifier having been obtained at the remotely accessible server by incorporating the at least one check digit into the raw account identifier.

18. (canceled)
